(19) United States
(12) Patent Application Publication
(10) Pub. No.: US 2026/0285397 A1
(43) Pub. Date: Sep. 24, 2026

(54) STEERING AND SUSPENSION DEVICE OF VEHICLE BODY

(71) Applicants: HYUNDAI MOTOR COMPANY, SEOUL (KR); KIA CORPORATION, SEOUL (KR)

(72) Inventors: Yuri Myoung, Hwaseong-si (KR); Jeong Chul Jung, Hwaseong-si (KR)

(73) Assignees: HYUNDAI MOTOR COMPANY, SEOUL (KR); KIA CORPORATION, SEOUL (KR)

(21) Appl. No.: 19/347,331

(22) Filed: Oct. 1, 2025

(30) Foreign Application Priority Data
Mar. 21, 2025 (KR) 10-2025-0036500

(51) Int. Cl. B62D 6/00; B60G 3/16; B62D 5/04

(52) U.S. Cl. CPC B62D 6/001; B60G 3/16; B62D 5/0418; B62D 5/0454; B62D 5/046

(57) ABSTRACT

A steering and suspension device of a vehicle body includes a rubber torsion axle extending in a direction perpendicular to the longitudinal direction of the vehicle body from the lower portion of the vehicle body of the vehicle, a rubber torsion arm provided on both sides of the rubber torsion axle, having one end connected to the end of the rubber torsion axle and the other end connected to a wheel of the vehicle, and together with the rubber torsion axle, alleviating a shock transmitted from the road surface to the vehicle body through the wheel, and a steering motor provided on the rubber torsion arm and providing a driving force to the wheel to cause the mobility vehicle to turn.

### CROSS REFERENCE TO RELATED APPLICATIONS

This application claims priority to and the benefit of Korean Patent Application No. 10-2025-0036500 filed with the Korean Intellectual Property Office on Mar. 21, 2025, the entire contents of which are incorporated herein by reference.

### BACKGROUND

### Field

The present disclosure relates to a steering and suspension device of a vehicle body, and more particularly, to a steering and suspension device a vehicle body having a rubber torsion type suspension and a steering motor.

### Description of the Related Art

Recently, a vehicle industry has introduced a new concept of future mobility visions for realizing a human-centered dynamic future city. One of these future mobility solutions is a PBV (purpose-built vehicle) as a purpose-based mobility.

An example of a PBV vehicle is an eco-friendly vehicle based on an electric vehicle (EV). These PBV vehicles may provide users with a variety of customized services while traveling from their starting point to their destination in an unmanned or manned autonomous manner.

A PBV vehicle 3 of this type may be composed of a cab type drive module 2 in which a drive device is employed and capable of autonomous driving, as illustrated in FIG. 1, and a space module 1 that is combined with the drive module 2 and used for cargo transport, passenger use, home office use, etc.

The driving module 2 and space module 1 may be configured as an underbody and an upper body that is respectively coupled to the upper part of the underbody and move together by the driving force of the underbody, respectively.

For the PBV vehicle 3, the platform should be as compact and flat as possible to secure maximum variable upper body space. However, suspensions mainly used in current passenger cars, such as a MacPherson strut suspension, have difficulty forming a low and flat upper surface due to their structural characteristics.

On the other hand, a rubber torsion suspension applied to a non-driven wheel, which is composed of a rubber torsion axle 10 and a rubber torsion arm 15 as shown in FIG. 2, has a compact and simple structure, but has the problem that it cannot be steered and may therefore only be applied to a non-driven axle. Therefore, there is a need to develop the compact rubber torsion type suspension structure that is capable of steering.

### SUMMARY

Therefore, according to one embodiment of the present disclosure, a steering and a suspension device of a vehicle body is provided that secures a vehicle body space, thereby increasing a convenience and enabling a configuration of a compact integrated module by configuring a rubber torsion type suspension that is arranged under a floor of the vehicle body and has a steering function while alleviating a shock transmitted to the vehicle body.

A steering and suspension device of a vehicle body according to an embodiment of the present disclosure as a steering and suspension device of a vehicle body that steers and cushions a wheel for a mobility vehicle, includes a rubber torsion axle extending in a direction perpendicular to the longitudinal direction of the vehicle body from the lower portion of the vehicle body of the vehicle; a rubber torsion arm provided on both sides of the rubber torsion axle, having one end connected to the end of the rubber torsion axle and the other end connected to a wheel of the vehicle, and together with the rubber torsion axle, alleviating a shock transmitted from the road surface to the vehicle body through the wheel, and a steering motor provided on the rubber torsion arm and providing a driving force to the wheel to cause the mobility vehicle to turn.

The steering and suspension device of the vehicle body according to an embodiment of the present disclosure may further include a worm gear connected to the steering motor and shaft rotating when the steering motor is operated, a worm wheel gear gear-coupled to the worm gear and rotating in a direction perpendicular to the axial direction of the worm gear for the axial rotation of the above worm gear, and a steering gear having one end gear-coupled to the worm wheel gear and the other end fixed to the shaft of the wheel so as to rotate in the opposite direction to the rotational direction of the worm wheel gear when the worm wheel gear rotates, thereby causing the shaft of the wheel to turn.

The steering motor may be fixedly secured to the outer side of the rubber torsion arm toward the inner side of the wheel.

The steering motor may be positioned on the opposite side of the wheel with the rubber torsion arm interposed therebetween.

The steering motor may have an outer surface covered by a steering motor cover.

The worm gear may be integrally and fixedly formed on the rotation shaft of the steering motor.

The rubber torsion arm may have a hollow space formed inside, and the worm gear, the worm wheel gear, and the steering gear may be provided inside the rubber torsion arm.

The worm wheel gear and the steering gear may be fixed to shaft rotate on the inner surface of the rubber torsion arm.

The steering motor may receive a steering angle signal transmitted from a central processing system of an autonomous driving system (AD system) to a motor electronic control unit (ECU) and a rotation direction and a rotation amount may be determined based on the steering angle signal.

The steering angle signal transmission from the motor electronic control device to the steering motor may be performed by a wireless communication.

The steering motor may operate so as to consume 0.3 kW to 0.5 kW of a power per a wheel.

The center axis of the wheel and the rotation axis of the steering gear may be positioned so as to be spaced apart from each other by a distance of 165 mm to 175 mm.

The wheel may be rotationally driven by an in-wheel motor including a rotor connected to the shaft of the wheel and a stator that rotates the rotor by applying a current.

On the central axis of the above in-wheel motor, a rotor disc brake which reduces or stops the rotational drive of the wheel by a mutual frictional action with a caliper may be provided.

According to one embodiment, the flat underbody structure and the platform may be implemented by integrating the suspension system formed of the rubber torsion suspension and the steering system formed of the steering motor.

In addition, by configuring the low and flat upper surface, the body space is secured above the steering and suspension devices, thereby lowering the loading floor height, increasing user convenience, and increasing the usability of the loading space, so it may be used as a mobility for various purposes.

Additionally, the drive and braking systems may be added together with the steering and suspension devices to form a compact integrated module.

### BRIEF DESCRIPTION OF THE FIGURES

FIG. 1 is a schematic diagram of a mobility vehicle PBV including a drive module and a space module.

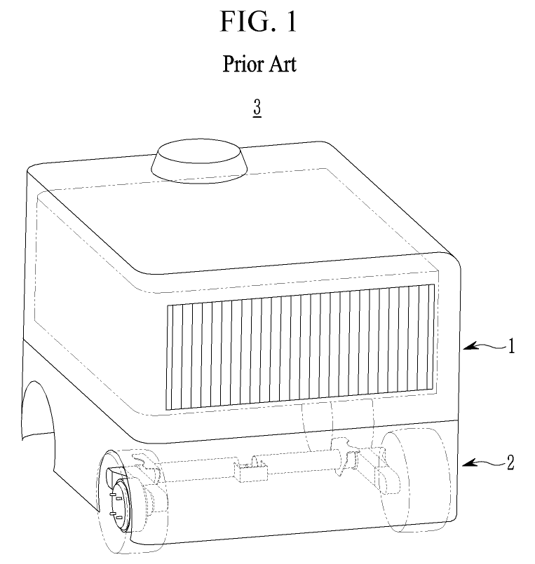

FIG. 2 is a view schematically illustrating a conventional rubber torsion type suspension structure.

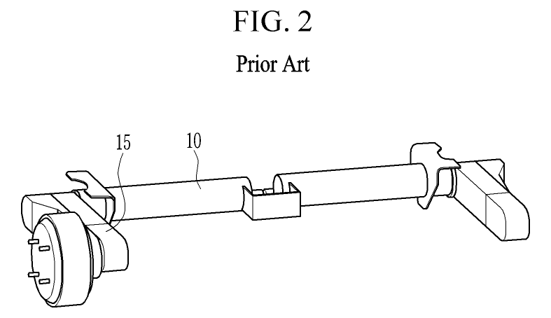

FIG. 3 is a view illustrating a steering and suspension device of a vehicle body according to one embodiment of the present disclosure.

FIG. 4 is a view illustrating a gear connection relationship for steering a wheel of a steering and suspension device of a vehicle body according to one embodiment of the present disclosure.

FIG. 5 is a view showing a steering operation state by driving a steering motor of a steering and suspension device of a vehicle body according to one embodiment of the present disclosure.

FIG. 6 is a view showing a steering non-operation state of a steering and suspension device of a vehicle body according to one embodiment of the present disclosure.

FIG. 7 is a view showing a left turn state of a vehicle by a steering operation of a steering and suspension device of a vehicle body according to one embodiment of the present disclosure.

FIG. 8 is a view showing a right-turn state of a vehicle by a steering operation of a steering and suspension device of a vehicle body according to one embodiment of the present disclosure.

FIG. 9 is a view illustrating a steering motor of a steering and suspension device of a vehicle body according to one embodiment of the present disclosure, wherein a steering motor cover is provided.

FIG. 10 is a view illustrating an in-wheel motor and a braking device added to a steering and suspension device of a vehicle body according to one embodiment of the present disclosure.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

Further, in the embodiments, like reference numerals designate like elements throughout the specification representatively in a first embodiment, and only elements of other embodiments other than those of the first embodiment will be described.

The drawings are schematic and not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. It will be understood that when an element such as a layer, film, region, or substrate is referred to as being “on” another element, it can be directly on the other element or intervening elements may also be present.

Embodiments of the disclosure are described through schematic illustrations of idealized embodiments of the disclosure. As such, variations from the shapes of the illustrations as a result are to be expected. Thus, embodiments of the disclosure should not be construed to be limited to the particular shapes of regions illustrated herein but are to include deviations in shapes that result, for example, from manufacturing.

Hereinafter, with reference to the attached drawings, a vehicle body steering and suspension device structure according to an embodiment of the present disclosure will be described in detail.

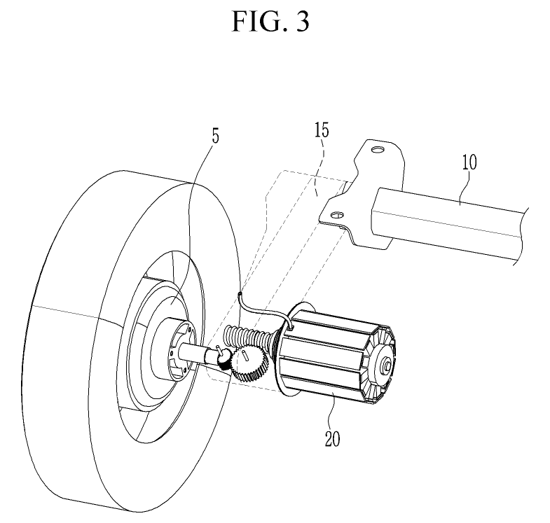

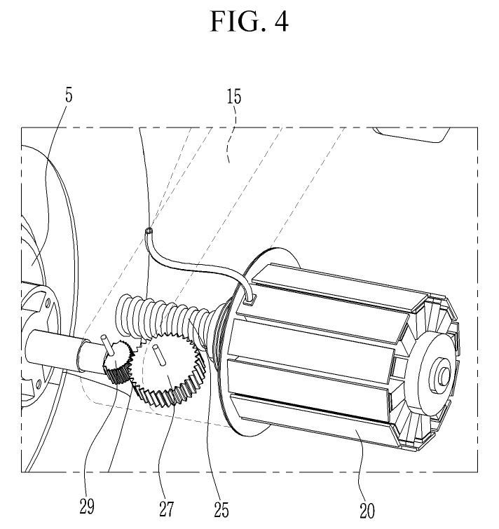

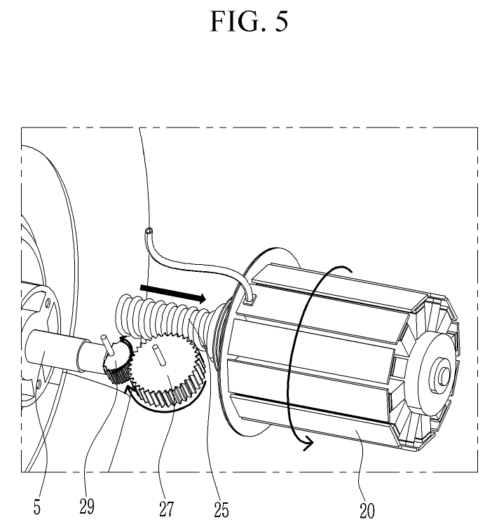

FIG. 3 is a view illustrating a steering and suspension device of a vehicle body according to one embodiment of the present disclosure, FIG. 4 is a view illustrating a gear connection relationship for steering a wheel of a steering and suspension device of a vehicle body according to one embodiment of the present disclosure, and FIG. 5 is a view showing a steering operation state by driving a steering motor of a steering and suspension device of a vehicle body according to one embodiment of the present disclosure.

Referring to FIGS. 3-5, a steering and suspension device of a vehicle body according to one embodiment of the present disclosure may be arranged under a floor of a vehicle body and may alleviate a shock transmitted from the outside to the vehicle body and, at the same time, steer a wheel 5 provided on the vehicle body.

The steering and suspension device of the vehicle body according to one embodiment of the present disclosure includes a rubber torsion axle 10, a rubber torsion arm 15, and a steering motor 20.

The rubber torsion axle 10 and the rubber torsion arm 15 form a rubber torsion suspension, which has a rubber inside and a plate surrounding the rubber, so that vibrations caused by a torsion or the like transmitted from the vehicle are absorbed by the rubber inside, thereby minimizing the vibrations and improving the shock absorption. This may minimize the vibration when cornering or turning the vehicle, thereby improving a ride comfort and a steering.

The rubber torsion axle 10 extends from the lower portion of the vehicle body in a direction perpendicular to the longitudinal direction of the vehicle body, and the rubber torsion arm 15 is connected to both sides of the rubber torsion axle 10 to extend in a direction perpendicular to the rubber torsion axle 10.

The rubber torsion arm 15 has one end connected to the end of the rubber torsion axle 10 and the other end connected to the wheel 5 of the vehicle, and together with the rubber torsion axle 10, may alleviate the shock and vibration transmitted from the road surface to the vehicle body through the wheel 5.

The steering motor 20 is provided on the rubber torsion arm 15 and provides the driving force to the wheel 5 to turn the mobility vehicle. The steering motor 20 may be fixedly installed on the outer side of the rubber torsion arm 15 toward the inner side of the wheel 5. Additionally, the steering motor 20 may be located on the opposite side of the wheel 5 with the rubber torsion arm 15 in between.

Meanwhile, the steering and suspension device of the vehicle body according to one embodiment of the present disclosure may further include a worm gear 25, a worm wheel gear 27, and a steering gear 29, as shown in FIG. 4.

The worm gear 25 is integrally and fixedly connected to the rotation shaft of the steering motor 20, and when the steering motor 20 is operated, the worm gear 25 also rotates by the rotation of the rotation shaft of the steering motor 20. As the rotation direction of the rotation shaft of the steering motor 20 changes, the rotation direction of the worm gear 25 changes accordingly.

The worm wheel gear 27 is gear-coupled to the worm gear 25 and arranged to rotate in a direction perpendicular to the axial direction of the worm gear 25. Depending on the direction of the rotation of the worm gear 25, the direction of the rotation of the worm wheel gear 27 changes.

The steering gear 29 has one side geared to the worm wheel gear 27 and the other side fixed to the shaft of the wheel 5. The rotation axis of the steering gear 29 is formed parallel to the rotation axis of the worm wheel gear 27, and rotates in the opposite direction to the rotation direction of the worm wheel gear 27 when the worm wheel gear 27 rotates. As the worm wheel gear 27 rotates, the axis of the wheel 5 fixed thereto rotates, causing the wheel 5 of the vehicle to be steered.

Meanwhile, the rubber torsion arm 15 has a hollow space formed inside, and the worm gear 25, the worm wheel gear 27, and the steering gear 29 may be provided inside the rubber torsion arm 15. The worm gear 25 is connected to the steering motor 20 shaft and extends inwardly through the outer surface of the rubber torsion arm 15, and the worm wheel gear 27 and the steering gear 29 are fixed to the upper and lower surfaces of the inner surface of the rubber torsion arm 15 so that their rotation axes may rotate.

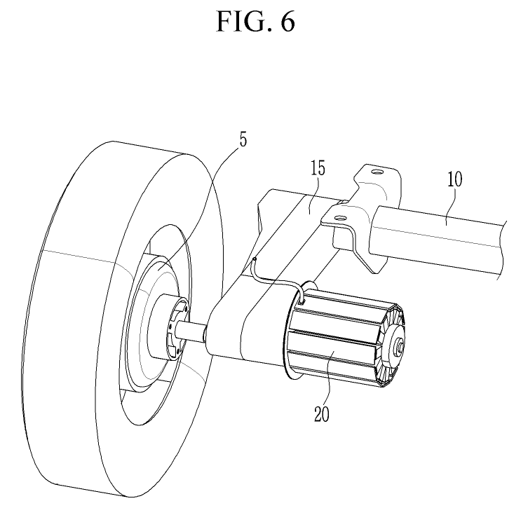

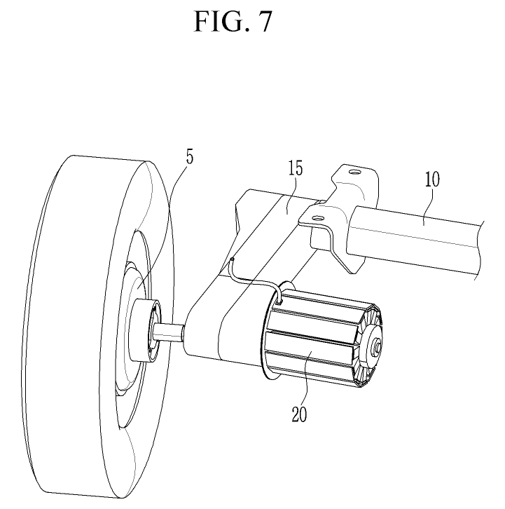

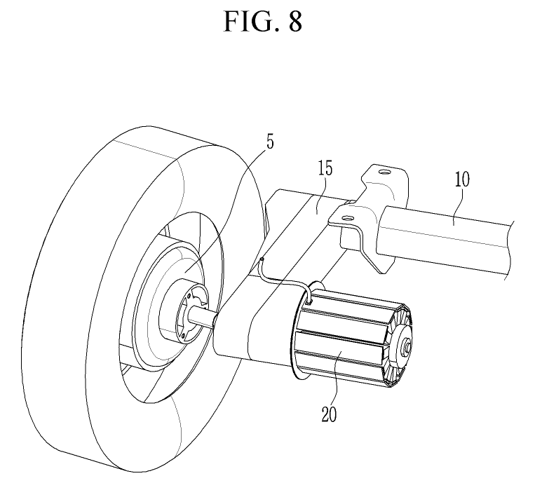

FIG. 5 is a view showing a steering operation state by driving a steering motor of a steering and suspension device of a vehicle body according to one embodiment of the present disclosure, FIG. 6 is a view showing a steering non-operation state of a steering and suspension device of a vehicle body according to one embodiment of the present disclosure, FIG. 7 is a view showing a left turn state of a vehicle by a steering operation of a steering and suspension device of a vehicle body according to one embodiment of the present disclosure, and FIG. 8 is a view showing a right-turn state of a vehicle by a steering operation of a steering and suspension device of a vehicle body according to one embodiment of the present disclosure.

Referring to FIG. 5, when the steering motor 20 shaft rotates in one direction (the first direction), the worm gear 25 connected to the steering motor 20 shaft rotates in the first direction. When the worm gear 25 shaft rotates in the first direction, the worm wheel gear 27 gear-coupled to the worm gear 25 shaft rotates in a direction (the second direction) perpendicular to the axial rotation direction of the worm gear 25. And, when the worm wheel gear 27 shaft rotates in the second direction, the steering gear 29 shaft rotates in the third direction, which is opposite to the second direction. Then, the wheel 5 axle fixed to the steering gear 29 turns in the third direction.

When the steering motor 20 rotates in the fourth direction, which is opposite to the first direction, the worm gear 25 also shaft rotates in the fourth direction, and the worm wheel gear 27 shaft rotates in the third direction. Accordingly, the steering gear 29 coupled to the worm wheel gear 27 rotates axially in the second direction. Then, the wheel 5 fixed to the steering gear 29 shaft rotates in the second direction.

Meanwhile, the tire center, i.e., the center axis of the wheel 5 and the rotation axis of the steering gear 29 may be positioned to be spaced apart from each other by about 165 mm to about 175 mm. By ensuring the sufficiently close distance between the rubber torsion arm 15 and the tire center, the amount of tire movement when the wheel 5 turns may be reduced.

Referring to FIG. 6, in the steering non-operation state of the steering and suspension device of the vehicle body, the steering motor 20 does not rotate, and accordingly, the worm gear 25, the worm wheel gear 27, and the steering gear 29 do not rotate. The wheel 5 axle is positioned in the direction perpendicular to the rubber torsion axle 10, so that the vehicle may travel straight without the turning.

FIG. 7 shows the left turn state of the vehicle by the steering operation of the steering and suspension device of the vehicle body. The steering motor 20 and the worm gear 25 shaft rotate in the first direction, and the worm wheel gear 27 shaft rotates in the second direction. And, the steering gear 29 shaft rotates in the third direction opposite to the second direction, so that the wheel 5 axis turns in the third direction, that is, so that the vehicle turns to the left.

FIG. 8 shows the right-rotating state of the vehicle due to the steering operation of the steering and suspension device of the vehicle body, and the axial rotation directions of the steering motor 20, the worm gear 25, the worm wheel gear 27, and the steering gear 29 are each opposite to the directions illustrated and described in FIG. 7. The wheel 5 axle turns in the second direction, causing the vehicle to turn right.

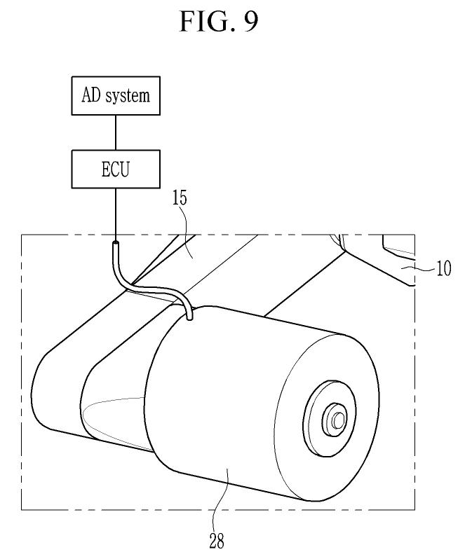

FIG. 9 is a view illustrating a steering motor of a steering and suspension device of a vehicle body according to one embodiment of the present disclosure, wherein a steering motor cover is provided.

Referring to FIG. 9, the outer surface of the steering motor 20 may be surrounded by a steering motor cover 28. The steering motor cover 28 is provided to cover the outer surface of the steering motor 20, and has one end opened and the other end closed. The worm gear 25 protrudes from the opened side of the steering motor cover 28.

Meanwhile, the steering motor 20 may receive a steering angle signal transmitted from a central processing system of an autonomous driving system (AD system) mounted on a mobility vehicle to an motor electronic control unit (ECU), and the rotation direction and rotation amount may be determined based on the steering angle signal. At this time, the steering angle signal transmission from the motor electronic control device to the steering motor 20 may be performed via a wireless communication.

A steering motor 20 may be provided on each of the front wheels on both sides of the vehicle body, and may consume an energy of about 0.8 kW during the steering. That is, the steering motor 20 may operate so as to consume about 0.3 kW to about 0.5 kW of a power per a wheel.

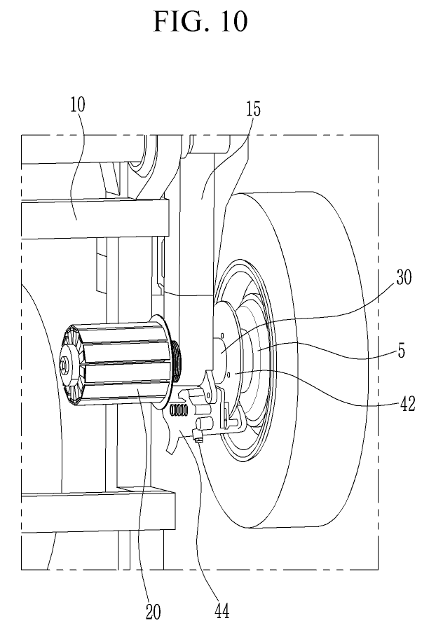

FIG. 10 is a drawing illustrating an in-wheel motor and a braking device added to a steering and suspension device of a vehicle body according to one embodiment of the present disclosure.

Referring to FIG. 10, a vehicle body steering and suspension device according to one embodiment of the present disclosure can be applied together with a driving system (in-wheel motor) and a braking system (brake disc). That is, the wheel 5 may be driven for the rotation by an in-wheel motor 30 composed of a rotor connected to the axis of the wheel 5 and a stator that rotates the rotor by applying a current. Additionally, a rotor disc brake 42 that reduces or stops the rotation of the wheel 5 through a frictional interaction with a caliper 44 may be provided on the central axis of the in-wheel motor 30.

In this way, by inserting and installing the gears inside the rubber torsion arm connected to the rubber torsion axle, the steering function may be enabled without using up a large amount of additional space.

Additionally, by bringing the center axis of the wheel and the rotation axis of the steering gear closer together, the amount of a tire movement during the steering may be reduced.

Additionally, a simple configuration of the steering device is possible through a wireless communication between the motor electronic control unit and the electric steering motor.

Additionally, a flat underbody structure and platform may be implemented by integrating the suspension system consisting of the rubber torsion suspension and the steering system consisting of the steering motor.

In addition, by configuring the low and flat upper surface, it secures the body space above the steering and suspension devices, thereby lowering the loading floor height, increasing the user convenience, and increasing the usability of the loading space, so it may be used as the mobility for various purposes.

Additionally, the drive and braking systems may be added together with the steering and suspension devices to form the compact integrated module.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. A steering and suspension device of a vehicle body of a mobility vehicle, comprising:
a rubber torsion axle extending from a lower portion of the vehicle body in a direction perpendicular to a longitudinal direction of the vehicle body;
a first rubber torsion arm having a first end connected to a first end of the rubber torsion axle, and a second rubber torsion arm having a first end connected to a second end of the rubber torsion axle, wherein the first rubber torsion arm has a second end connected to a wheel of the mobility vehicle;
wherein the rubber torsion axle and the first and second rubber torsion arms are configured to alleviate a shock transmitted from a road surface to the vehicle body through the wheel; and
a steering motor positioned on the first rubber torsion arm and configured to provide a driving force to the wheel to cause the mobility vehicle to turn.

2. The steering and suspension device of the vehicle body of claim 1, further comprising:
a worm gear connected to the steering motor, the worm gear having a shaft configured to rotate when the steering motor is operated;
a worm wheel gear coupled to the worm gear and configured to rotate in a direction perpendicular to an axial direction of the worm gear for axial rotation of the worm gear; and
a steering gear having a first end coupled to the worm wheel gear and a second end fixed to a shaft of the wheel to rotate in a direction opposite to the rotational direction of the worm wheel gear when the worm wheel gear rotates, thereby turning the shaft of the wheel.

3. The steering and suspension device of the vehicle body of claim 1, wherein the steering motor is secured to an outer side of the rubber torsion arm toward an inner side of the wheel.

4. The steering and suspension device of the vehicle body of claim 1, wherein the steering motor is positioned on an opposite side from the wheel with the rubber torsion arm interposed therebetween.

5. The steering and suspension device of the vehicle body of claim 1, further comprising a steering motor cover positioned on an outer surface of the steering motor.

6. The steering and suspension device of the vehicle body of claim 2, wherein the worm gear is integrally formed on a rotation shaft of the steering motor.

7. The steering and suspension device of the vehicle body of claim 6, wherein:
the first and second rubber torsion arms each have a hollow space formed inside, and
the worm gear, the worm wheel gear, and the steering gear are positioned inside each of the first and second rubber torsion arms.

8. The steering and suspension device of the vehicle body of claim 7, wherein the worm wheel gear is fixed to a shaft of the worm wheel gear and the steering gear is fixed to a shaft of the steering gear on an inner surface of each of the first and second rubber torsion arms.

9. The steering and suspension device of the vehicle body of claim 1, wherein:
the steering motor is configured to receive a steering angle signal transmitted from a central processing system of an autonomous driving (AD) system to a motor electronic control unit (ECU), and a rotation direction and a rotation amount are determined based on the steering angle signal.

10. The steering and suspension device of the vehicle body of claim 9, wherein the steering angle signal transmission from the motor ECU to the steering motor is performed by a wireless communication.

11. The steering and suspension device of the vehicle body of claim 1, wherein the steering motor is configured to consume 0.3 kW to 0.5 kW of power per el.

12. The steering and suspension device of the vehicle body of claim 2, wherein a center axis of the wheel and a rotation axis of the steering gear are spaced apart from each other by a distance of 165 mm to 175 mm.

13. The steering and suspension device of the vehicle body of claim 1, wherein the wheel is rotationally driven by an in-wheel motor including a rotor connected to the shaft of the wheel, and a stator configured to rotate the rotor by applying a current.

14. The steering and suspension device of the vehicle body of claim 13, wherein on a central axis of the in-wheel motor,
a rotor disc brake is positioned on a central axis of the in-wheel motor, the rotor disc brake being configured to reduce or stop a rotational drive of the wheel by a mutual frictional action with a caliper.

15. A vehicle comprising:
a vehicle body;
at least one wheel connected to the vehicle body;
a rubber torsion axle having a first end and a second end, the rubber torsion axle extending from a lower portion of the vehicle body in a direction perpendicular to a longitudinal direction of the vehicle body;
a rubber torsion arm having a first end connected to the first end of the rubber torsion axle, and a second end connected to the at least one wheel of the vehicle; and
a steering motor positioned on the rubber torsion arm and configured to provide a driving force to the at least one wheel to turn the vehicle;
wherein the rubber torsion axle and the rubber torsion arm are configured to alleviate a shock transmitted from a road surface to the vehicle body through the wheel.

16. The vehicle of claim 15, further comprising:
a worm gear connected to the steering motor, the worm gear having and a shaft configured to rotate when the steering motor is operated;
a worm wheel gear coupled to the worm gear and configured to rotate in a direction perpendicular to an axial direction of the worm gear for axial rotation of the worm gear; and
a steering gear having a first end coupled to the worm wheel gear and a second end coupled to a shaft of the at least one wheel to rotate in a direction opposite to the rotational direction of the worm wheel gear when the worm wheel gear rotates, thereby turning the shaft of the wheel.

17. The vehicle of claim 16, wherein the worm gear is integrally formed on a rotation shaft of the steering motor.

18. The vehicle of claim 15, further comprising a steering motor cover positioned on an outer surface of the steering motor.

19. The vehicle of claim 18, wherein the rubber torsion arm each has a hollow space formed inside, and the worm gear, the worm wheel gear, and the steering gear are positioned inside the rubber torsion arm.
